(19) United States
(12) Patent Application Publication
(10) Pub. No.: US 2008/0028289 A1
(43) Pub. Date: Jan. 31, 2008

(54) Form filling lens

(75) Inventors: Ryan C. Hicks, Stockton, CA (US); Yohko A.F. Kelley, Woodinville, WA (US); David Zuverink, San Jose, CA (US)

Correspondence Address: KOKKA & BACKUS, PC, 200 PAGE MILL ROAD, SUITE 103, PALO ALTO, CA, 94306, US

(73) Assignee: Adobe Systems Incorporated, San Jose, CA (US)

(21) Appl. No.: 11/494,180

(22) Filed: Jul. 26, 2006

(51) Int. Cl. G06F 17/00

(52) U.S. Cl. 715/224; 715/221; 715/225

(57) ABSTRACT

Techniques for implementing a form filling lens are described, including displaying at least a portion of a form, the portion comprising a first field configured to receive data, drawing a lens comprising a first data entry area to receive a first input comprising the data, receiving the first input using the first data entry area, and entering the data in the first field.

### FIELD OF THE INVENTION

The present invention relates generally to software. More specifically, a form filling lens is described.

### BACKGROUND OF THE INVENTION

A form may be used to collect and categorize information including various data that one party may want to receive from another party. Forms may include, for example, application forms, tax forms, expense forms, and payment forms. A form may include one or more fields into which individual data points may be entered. For example, a form may include fields asking for a user's first name, last name, street address, city, and state of residence.

Forms may be electronic and filled using electronic devices. For example, a form may be completed using a software application run on a processing system such as a personal computer. The software application may present the form to a user using a visual medium (e.g., a display), collect the data inputted by the user, and store the data in a digital format (e.g., as a file). The data can then be transmitted to other users. However, forms may be complex and users are often uncertain of how to complete certain fields of a form using conventional solutions. Further, forms may have inadequate or altogether lack instructions regarding how to fill fields on a form.

Thus, what are needed are techniques for filling forms without the limitations of conventional techniques.

### BRIEF DESCRIPTION OF THE DRAWINGS

Various embodiments of the invention are disclosed in the following detailed description and the accompanying drawings:

FIGS. 1A-1C illustrate form filling including a lens in accordance with various embodiments;

FIG. 2 illustrates form filling include a lens having a data entry area appearing to be a visual representation of a field;

FIG. 3 is a flowchart describing a process for filling a form using a lens according to various embodiments; and

FIG. 4 is a block diagram illustrating an exemplary computer system suitable for using a lens for filling forms, in accordance with various embodiments.

### DETAILED DESCRIPTION

Various embodiments of the invention may be implemented in numerous ways, including as a system, a process, an apparatus, or a series of program instructions on a computer readable medium such as a computer readable storage medium or a computer network where the program instructions are sent over optical or electronic communication links. In general, operations of disclosed processes may be performed in an arbitrary order, unless otherwise provided in the claims.

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

According to various embodiments, a lens for filling forms is described. A lens may be a visual element used to aid a user with filling and navigating a form. A form may include one or more fields for which data is requested. A lens may operate on one or more fields when the field is in focus. The lens may include a data entry area (separate from the field in focus) into which a user may enter the data requested for the field. The lens may further include controls for navigating about the form and instructions for filling the fields of the form. According to some embodiments, the data entry area remains in a constant position relative to a display to assist the user in filling the form.

### Lens for Entering Data into Fields of a Form

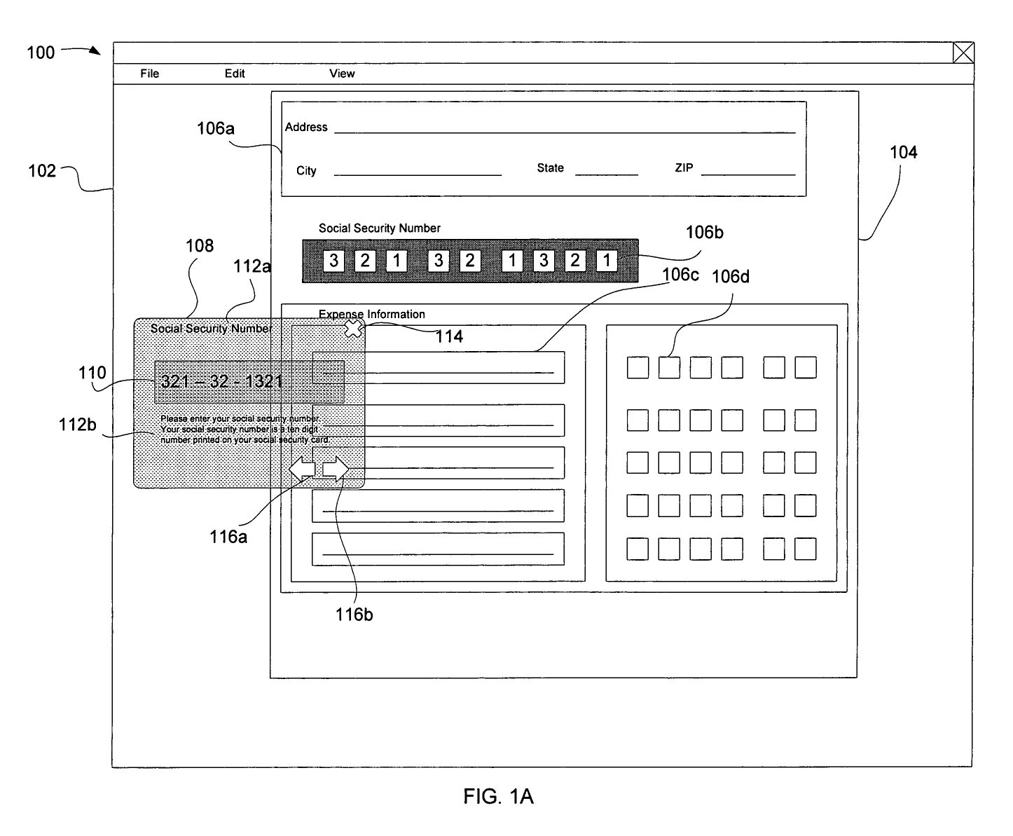

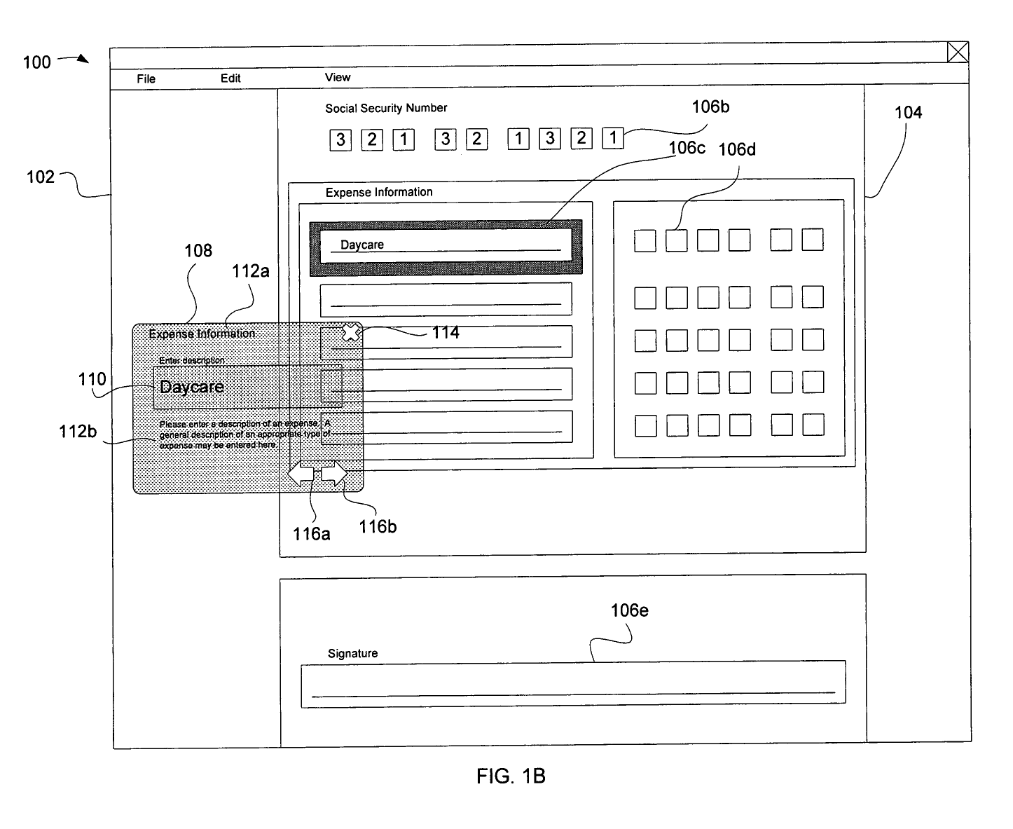

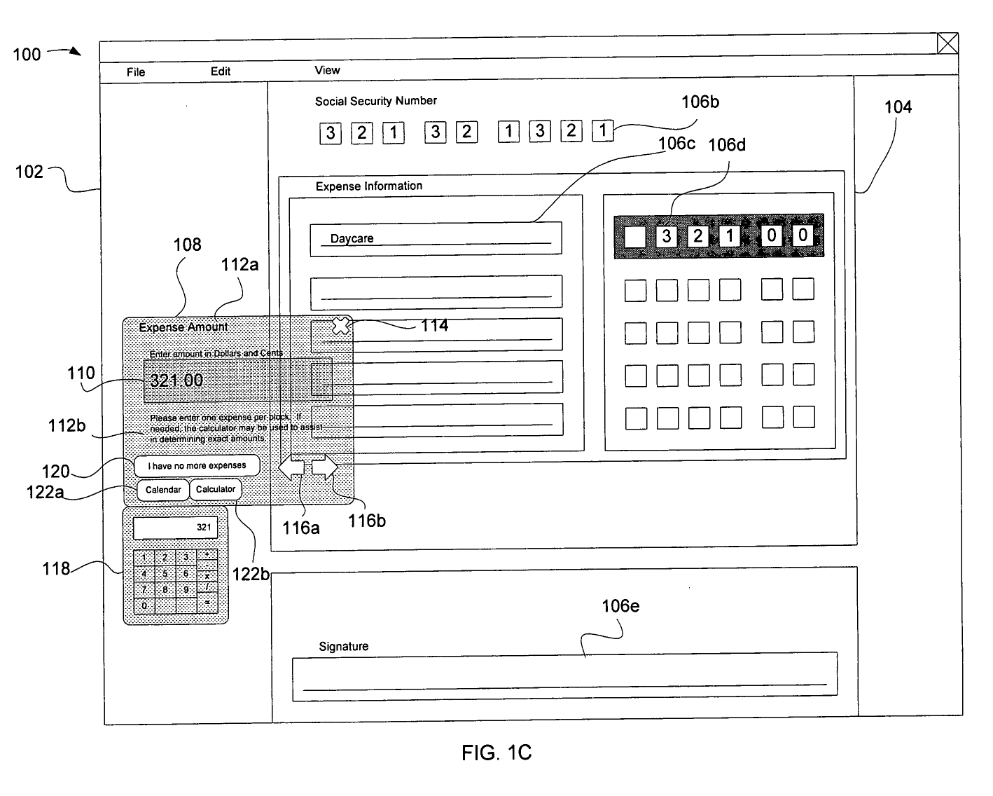

FIGS. 1A-1C illustrate form filling including a lens in accordance with various embodiments. Form filling software 100 allows a user to input data into a form. For example, the form filling software may be operating on a form such as a tax form or expense report. The form may request data in one or more fields. The user may use a lens displayed by the form filling software 100 to complete the form. The form filling software 100 may be a standalone application or may be incorporated into other software (e.g., viewing or authoring software). Alternatively, the form filling software 100 may be representative of any other implementation that may be used to complete a form. In other words, the form filling software 100 may be implemented as software, hardware, firmware, circuitry, or a combination thereof and is not limited to the techniques described.

The form filling software 100 includes a lens that may be used to enter data into the form. The lens also allows a user to navigate about a form, and provides information to the user about the requested data. The lens may also be used as a proxy to enter data into the form. In this respect, the lens is a central data entry point where a user may enter data, obtain information about the data to be entered, and receive help determining (e.g., finding or calculating) and entering the data.

FIG. 1A illustrates the form filling software 100 being used to input a numerical value according to an embodiment. The form filling software 100 is displayed in a window 102 and is operating upon a form 104. The form 104 may be, for example, any form used to collect and organize data into one or more fields. The form 104 may also be any type of form, such as a tax form, application form, purchase agreement, or rebate form. A form may, in some embodiments, be stored using a data storage container such as a file.

In some embodiments, the form 104 may include one or more fields 106a-106d that may be used to input and contain individual data points (e.g., a social security number, a description of an expense, an amount of an expense, and others). A field may be any container used to store data input by a user or process. “Data,” as used herein, is any type of information that may be requested of a user and stored in a field. For example, data may include numbers, words, alphanumeric strings, tables, images or other media, or combinations thereof. A field may be used to store a single data point (e.g., a number or word) or a larger data structure (e.g., a string of words, a table of data, or an image).

The form 104 may further include metadata, which is not visible to the user and that describes the fields 106. For example, the metadata may indicate that the field 106a is configured to store a user's address using alphanumerical strings, or that the field 106b is to store a user's social security number using nine individual digits. The metadata may be used by the form filling software 100 for various purposes, some of which are described below.

The form filling software 100 further includes a lens 108. In some embodiments, a lens may be a visual element drawn over or near a form that may assist a user while inputting data into a form. Here, the lens 108 includes a data entry area 110, help information 112, a close button 114, and navigation arrows 116. The lens 108 may receive data from a user input and may include information to assist a user who is completing the form 104.

As shown here, the lens 108 is currently accepting data to input into the field 106b because the field 106b is in “focus”. In some embodiments, a field is in focus when it is currently active or when it has been selected by a user or other process. A user may select a field to bring it into focus by, for example, clicking on the field, tabbing into the field, or completing a previous field such that the form automatically advances to the current field. The field 106b (i.e., the field in focus) may be highlighted (as shown) to indicate the focus. Once the field is brought into focus, the lens 108 appears or is redrawn to indicate that a new field is in focus. The user may further determine whether the lens 108 appears upon focus, for example, toggling the lens 108 “on” or “off” using a menu option. In other embodiments, more than one field may be in focus simultaneously or substantially simultaneously, and the lens 108 may include multiple data entry areas for the multiple fields.

The lens 108, as described below, may also be used to aid navigation of the form 104. The form 104 may be navigated using features of the lens to allow the lens 108 to move to different fields of the form 104. For example, once a user has finished filling in the field 106b, the form 104 may advance to the field 106c. The lens 108 is then redrawn to display information for, and accept data for the next field 106c. The order of the fields may be determined by examining the metadata of the form 104 or by examining the relative position of fields within the form 104. Alternatively, the user may also navigate the form 104 by bringing any field into focus. When the user brings a field into focus, the lens 108 is redrawn for the field that the user has chosen.

A user may input data into the data entry area 110. For example, here the user has been prompted to enter her social security number. The user may type into the data entry area 110 in order to enter her social security number into the field 106b. The data entry area 110 may correspond to a data type of the field. For example, the field 106b may accept a numerical value, which may include nine digits. Therefore, the data entry area 110 may accept nine digits when the field 106b is in focus.

According to some embodiments, when the user inputs the data into the data entry area 110, the inputted data is simultaneously inputted into the field that is currently in focus (e.g., the field 106b). According to other embodiments, the user may input data into the data entry area 110, and the lens 108 may enter the data into the current field (e.g., the field 106b), after the user has indicated that she is finished (e.g., by performing a carriage return). According to further embodiments, the data entry area 110 is separate from the field into which data is input (e.g., the field in focus, or as shown, the field 106b) so that the data entry area 110 and the current field 106b are both visible.

The lens 108 may further include help information 112, which describes the type of data that may be input into the data entry area 110. The help information may include, for example, a title 112a and a description 112b. The title 112a may generally describe the contents of the field 106b (e.g., “Social Security Number”), while the description 112b may include a longer explanation of the type of data to be input. For example, the description 112b may include information about where to find or how to determine the data to input into the data entry area 110 (and therefore the field 106b).

The lens 108 further includes a button 114 that a user may select (e.g., using a pointing device such as a mouse) to disable the lens 108, and two arrows 116a and 116b that allow a user to navigate about the fields 106 of the form 104. For example, a user may select the arrow 116b to advance from the current field (i.e., the field in focus) 106b to the next field 106c. The arrow 116a may be selected to return to the previous field 106a. When the arrows 116 are used, the focus changes to the selected field, and the lens 108 changes to accommodate the selected field (e.g., a new data entry area 110, and new help information 112). The order of the fields 106 may be determined using various techniques such as examining metadata of the form 104 or by following the general layout of the form 104.

The form filling software 100 may advance to the next field 106c in response to one of several occurrences. First, a user may select the arrow 116b to manually advance the form 104. Secondly, the form 104 may be automatically advanced once the requested data has been input into the area 110. For example, once a user has input the final digit of their social security number into the area 110, the form 104 automatically advances to the field 106b. According to other embodiments, the form 104 may advance in response to another input, such as a carriage return, after the user has finished inputting the requested data, or after a predetermined amount of time has elapsed (e.g., ten seconds) without input (i.e., typing) from the user.

The lens 108 may further have a reduced opacity to give it a translucent or transparent appearance. The reduced opacity may allow the form filling software 100 to locate the lens 108 over the form 104 to keep the lens 108 and the field 106a in close proximity while still allowing a user to see the portion of the form 104 covered by the lens 108.

The form filling software 100 may also perform error checking after receiving an input to enter the data into the data entry area 110 and before entering the data into the field in focus. For example, the form filling software 100 may determine that a numerical value is outside an allowed range, or that textual data is of the wrong format. The form filling software 100 may also inform the user of the error, and advise a course of action.

FIG. 1B illustrates the input of textual data into the field 106c using the lens 108 according to an embodiment. The form 104 may be advanced from the field 106b to the field 106c in response to one of several occurrences, such as those described above. When the form 104 is advanced, it may, as shown here, be redrawn so that the form appears to have moved. For example, the field 106a is no longer visible, while a new field, the field 106e is visible. Additionally, the field 106c has been moved so that it is not underneath the lens 108 and the data entry area 110 is separated from the field 106c.

According to some embodiments, the lens 108 may maintain an approximately constant position relative to the display of the form filling software 100, while the form 104 may or may not move. Maintaining a constant position of the lens 108 may assist a user of the form filling software 100; however, it is understood that the lens 108 may take any position and may move (i.e., be redrawn in a different position) as desired.

The field 106c is highlighted to indicate that focus has been applied to the field 106c; accordingly, highlighting has been removed from the field 106b. The field 106c, as shown here, may receive data including text to describe an expense. The field 106d may receive data concerning a corresponding dollar value for the expense described in the field 106c.

Here, the contents of the lens 108 have been redrawn to indicate the change from the field 106b to the field 106c. The title 112a now reflects the title of the field 106c, and the description 112b includes information for filling out the field 106c. For example, the field 106c may be used to describe an expense listed on an expense form. As above, a user may enter the requested data into the data entry area 110. The data entry area 110 may be redrawn to correspond to a data type of the field 106c (e.g., to receive a textual input). Once the data has been entered in the data entry area 110, the data is entered in the field 106c in the form 104.

The form 104 may again be advanced once the requested data has been entered in the field 106c. As described above, the form 104 may be advanced either automatically, in response to a user input selecting the arrow 116b, or in response to a user selecting another field (e.g., by clicking on another field). For example, the form 104 may be automatically advanced after a pause (e.g., five seconds after the user has finished typing) or in response to a carriage return.

FIG. 1C illustrates the input of a numerical value into the field 106c using the lens 108 and a widget 118 to assist a user, according to some embodiments. The form 104 has again advanced; the field 106d is highlighted while the highlighting has been removed from the field 106c. Additionally, the contents of the lens 108 have changed once again to reflect advancement of the lens 108 over the field 106d. The lens 108 now includes the title 112a and a new description 112b that describe the type of data requested for the field 106c. For example, the data requested is an amount of an expense, which may be described in the field 106c. As shown here, the form 104 has not been redrawn because the fields 106c and 106d are next to each other.

In some embodiments, the lens 108 may also include a widget 118, which may be drawn either externally or internally to the lens 108. According to an embodiment, the widget 118 is drawn adjacent to the lens 108. A widget 118 is a device that a user may use to help determine the data requested for the current field. For example, the widget 118 as shown here is a calculator. Other types of widgets may include calendars, mortgage calculators, or address books. According to an embodiment, a widget may appear when a corresponding field is brought into focus. For example, the widget 118 may appear when the field 106d is brought into focus.

Here, a calculator is used since the data requested for the field 106d is a value that may be calculated. For example, a user may have a number of receipts, the total of which may be determined using the widget 118. The value shown in the widget 118 may be automatically transferred to the data entry area 110 (and thus, the field 106c), or in response to a user input (e.g., clicking a button).

According to some embodiments, forms may include multiple similar fields. For example, the form 104 includes several fields for inputting expense information when a user has multiple expenses. However, a user may not need to use every available field. Therefore, the lens 108 may include a button 120, which a user may select to indicate that the form 104 may advance past the remaining similar fields (e.g., to the signature field 106e). The button 120 may be selected if the user has no more expenses to enter, for example. The button 120, or other similar button, may be located in or near the lens 108, and may be used with any set of fields that contain similar information in a list style format such as lists of expenses, dependents, or employees.

According to another embodiment, widgets may be optionally activated using a button within the lens 108. For example, a button 122a may be included within the lens 108. The button 122a may be optionally added to the lens 108 by a designer of the form 104 or in response to a user request to add the button 122a. The button 122a may be selected to open or close an additional widget, such as a calendar or other widget. A user may toggle the additional widget on or off by selecting or deselcting the button 122a. When a user selects the button 122a to open an additional widget, the additional widget may be presented in place of or in addition to the existing widget 118. According to another embodiment, the button 122 may be included to activate a widget where no other widget is currently active (e.g., as shown in FIGS. 1A and 1B). A button 122b may also be added to indicate that both the calculator widget 118 and a calendar are available simultaneously. The button 122b may be nonfunctional (e.g., it shows that widget 118 is active), or it may be selected or deselected to add or remove the widget 118. As described above, the widget 118 may also automatically appear when the field 106d is brought into focus.

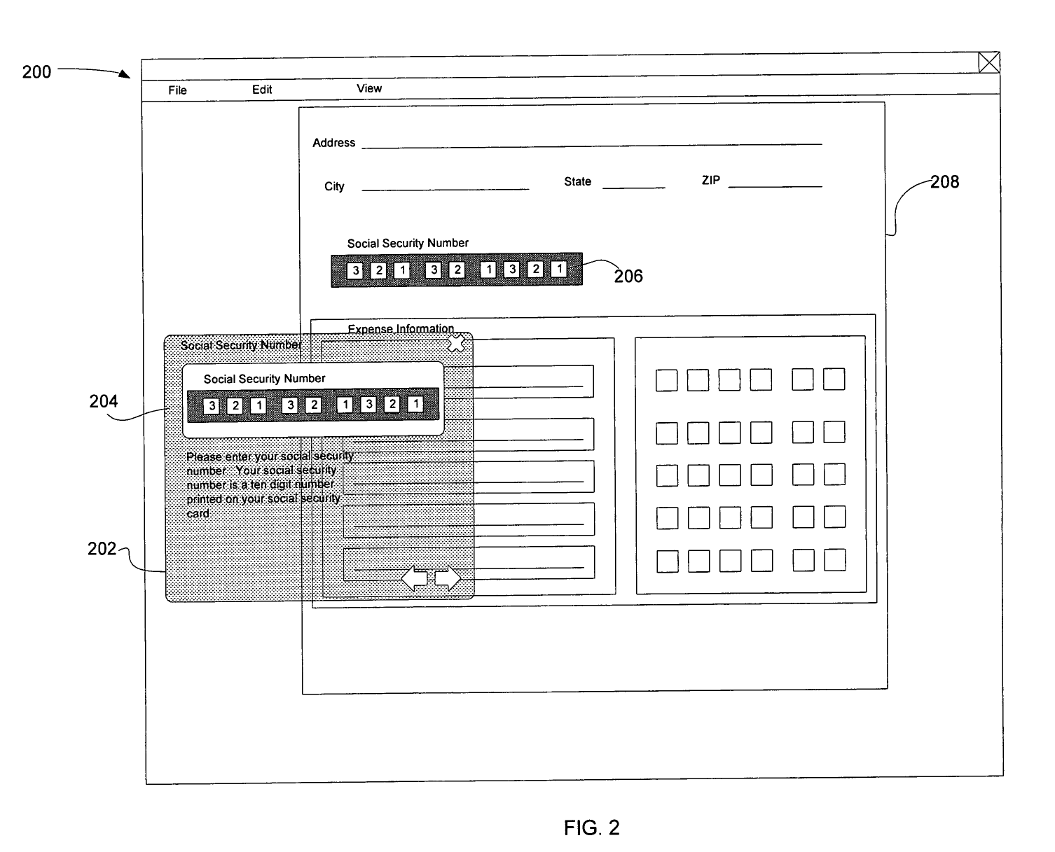

FIG. 2 illustrates form filling software 200 including a lens 202 having a data entry area 204 appearing as a visual representation of a field 206 of a form 208. According to some embodiments, the lens 202 may show a visual representation of the field 206 of the form 208. For example, when the field 206 is in focus (i.e., active), the data entry area 204 into which a user inputs the requested data shows a visual representation of the field 206 as it appears in the form 208. In other embodiments, the form filling software 100 may be implemented as software, hardware, firmware, circuitry, or a combination thereof and is not limited to the techniques described.

Here, the form filling software 200 may be used with forms that do not contain metadata. Alternatively, the form filling software 200 may be used where a designer of the form wishes to enhance the display of certain elements of the form 208. For example, a user may want to see the field in which he is inputting data. Using the lens 202, the user can see multiple fields in the same location as those appearing on the form 208.

The form filling software 200 may copy the visual appearance of the field 206 into the data entry area 204. The data entry area 204 may function in a manner similar to the field 206. In other words, a user may enter data into the data entry area 204 as though the user is being entering data into the field 206. Using the lens 208 in this manner still allows the user to have a centralized entry point for filling the form 208. In other embodiments, the visual representation may be the same size or small than the field 206.

### Process for Filling a Form Using a Lens

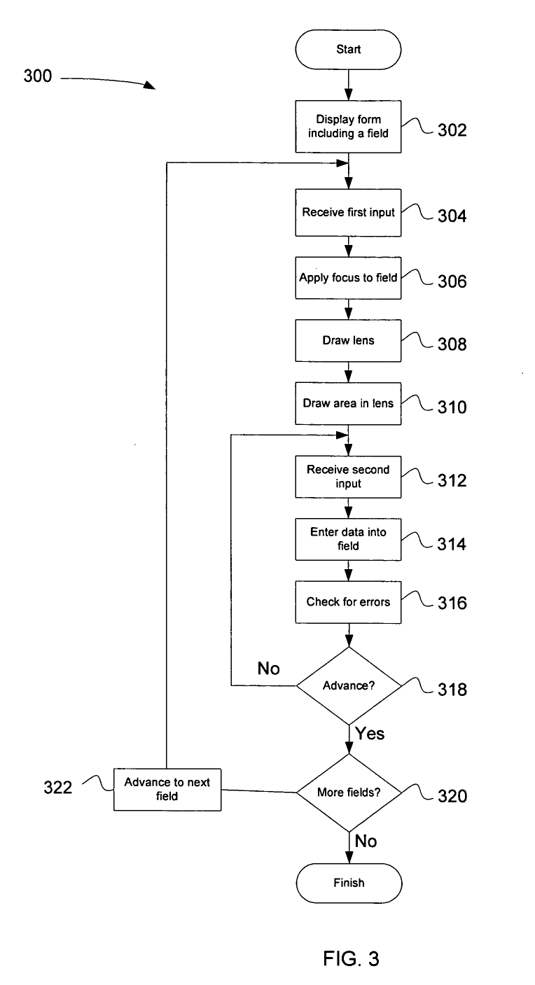

FIG. 3 is a flowchart describing a process 300 for filling a form using a lens according to various embodiments. The process 300 generally describes receiving inputs from a user to fill a form using a form filling software (e.g., the form filling software 100) or other appropriate implementation. The process 300 may be performed using software, hardware, firmware, circuitry, or a combination thereof and is not limited to the techniques described.

In block 302, a form is displayed. A displayed form may include a portion or a complete form, which may further include a field configured to receive data. The form may be, for example, a tax form, an application, or a purchase order. The field may receive data input by a user, for example into a data entry area.

In block 304, a first input is received. The first input may be an input to select a field to focus upon. For example, the first input may include a mouse click or keystroke. As described above, focus may indicate that a field has been selected using, for example, a keystroke or mouse click. In block 306, in response to the first input, focus is applied to a selected field. Applying focus to the field may, according to some embodiments, including highlighting the field. In other embodiments, one or more fields may be focused upon simultaneously.

In block 308, a lens is drawn in response to the focus being applied. Drawing the lens may include any technique to graphically render or display the lens. The lens may be, for example, a visual element drawn over or near portions of the form. The lens may include a data entry area into which requested data may be input by a user. In block 310, the data entry area may be drawn inside the lens and separated from the field. The data entry area, in some embodiments, may be separated from the field to allow a user to view the field while entering data into the area. The lens may further include help information such as a description of the type of data requested, as well as instructions about how to fill in the field.

In block 312, a second input is received. The second input may be received using the data entry area. For example, the second input may be an input from a user to enter data into the data entry area. In block 314, the data is entered into the field. The data may be transferred to the field from the data entry area as the data is being entered by the user (i.e., as each character of the second input is being received), or after the user has finished entering the data. Alternatively, the data may be entered once a user has completed entering the data (e.g., when all digits of a social security number have been entered), or when a user indicates that they are finished (e.g., by performing a carriage return).

In block 316, error checking is optionally performed. Error checking may include determining whether the second input conforms to a format of the field, whether the second input includes the correct type and amount of data, and whether the data falls within a predetermined range, for example. If an error is found, an alert notifying the user of the error may be initiated.

In block 318, it is determined whether the form should be advanced. The form may be advanced in response to one of several conditions. For example, the user may select one of the arrows 116, or the form may be configured to automatically advance once the requested data has been entered by the user. If the form is not advanced, the process returns to block 312, where more input for the current field is received. If the form is to advance, the process continues to block 320.

In block 320, it is determined whether there are other fields in the form. The determination may be based on whether there are other incomplete fields, or whether there are any more fields before the end of the form, for example. If there are no more fields, the process 300 finishes. If there are more fields, the process 300 continues to block 322, where the form advances to the next field (e.g., focus is applied to the next field).

### An Exemplary Computer System

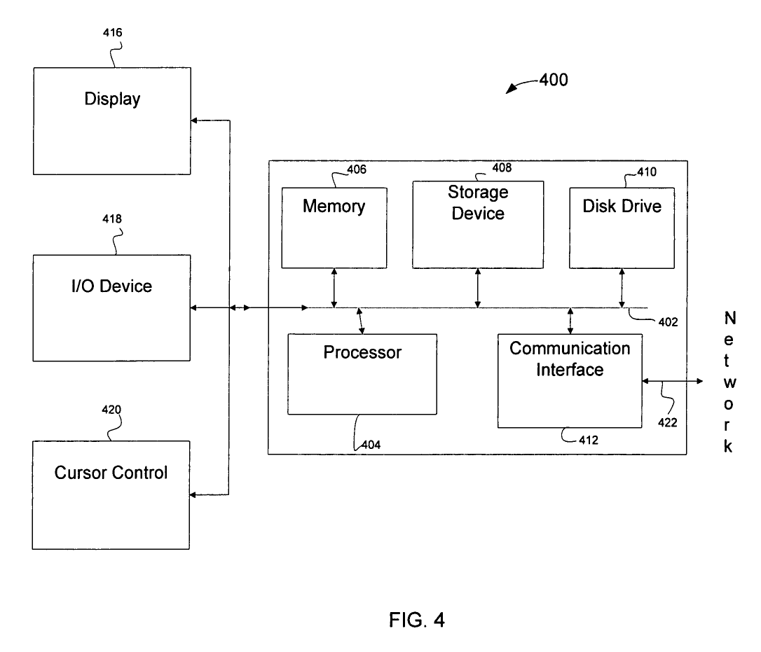

FIG. 4 is a block diagram illustrating an exemplary computer system suitable to fill forms using a lens, in accordance with various embodiments. In some embodiments, a computer system 400 may be used to implement computer programs, applications, methods, processes, or other software to perform the above-described techniques. The computer system 400 includes a bus 402 or other communication mechanism for communicating information, which interconnects subsystems and devices, such as a processor 404, a system memory 406 (e.g., RAM), a storage device 408 (e.g., ROM), a disk drive 410 (e.g., magnetic or optical), a communication interface 412 (e.g., modem or Ethernet card), a display 414 (e.g., CRT or LCD), an input device 416 (e.g., keyboard), and a cursor control 418 (e.g., mouse or trackball).

According to some embodiments, the computer system 400 performs specific operations by processor 404 executing one or more sequences of one or more instructions stored in the system memory 406. Such instructions may be read into the system memory 406 from another computer readable medium, such as the static storage device 408 or the disk drive 410. In some embodiments, hard-wired circuitry may be used in place of or in combination with software instructions to implement various embodiments.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method comprising:
displaying at least a portion of a form, the portion comprising a first field configured to receive data;
drawing a lens comprising a first data entry area to receive a first input comprising the data;
receiving the first input using the first data entry area; and
entering the data in the first field.

2. The method of claim 1, further comprising applying a focus to the first field in response to a second input selecting the first field.

3. The method of claim 2, wherein drawing the lens comprises drawing the lens in response to the applying the focus.

4. The method of claim 3, further comprising:
displaying a second field of the form configured to receive additional data;
applying the focus to the second field after the entering the data;
redrawing the lens comprising a second data entry area in response to the applying the focus to the second field;
receiving a third input comprising the additional data using the second data entry area; and
entering the additional data in the second field.

5. The method of claim 4, further comprising applying the focus to the second field in response to the receiving a fourth input to select the second field and determining that the third input satisfies a predetermined condition, wherein the predetermined condition indicates the form has been advanced.

6. The method of claim 1, wherein the lens further comprises the first data entry area corresponding to a data type of the first field.

7. The method of claim 1, further comprising drawing a widget adjacent to the lens.

8. The method of claim 7, further comprising using the widget to assist a user.

9. The method of claim 1, further comprising checking the first input for an error.

10. The method of claim 1, wherein drawing the lens further comprises drawing the first data entry area, wherein the first data entry area is configured to appear as a visual representation of the first field.

11. The method of claim 4, wherein redrawing the lens comprises redrawing the lens maintaining an approximately constant position.

12. The method of claim 11, further comprising redrawing the form so that the form appears to have moved.

13. The method of claim 1, further comprising providing information about the first field using the lens.

14. A method comprising:
displaying a form, the form comprising a first field configured to receive data;
receiving a first input selecting the first field;
applying a focus to the first field in response to receiving the first input;
drawing a lens comprising help information about the first field;
drawing a first data entry area in the lens;
receiving a second input comprising the data using the first data entry area; and
entering the data into the first field.

15. The method of claim 14, wherein the drawing the lens further comprises drawing a navigation arrow to enable a user to navigate the form.

16. The method of claim 14, wherein drawing the lens further comprises providing help information comprising a title of the first field and information about filling the first field.

17. The method of claim 14, flurther comprising:
displaying a second field of the form, the second field being configured to receive a second data;
applying the focus to the second field after the entering the first data;
redrawing the lens comprising a second data entry area in response to applying the focus to the second field;
receiving a third input comprising the second data using the second data entry area; and
entering the second data in the second field.

18. A system, comprising:
a memory configured to display a form; and
a processor configured to:
display at least a portion of the form, the portion comprising a first field configured to receive data;
draw a lens comprising a first data entry area to receive a first input comprising the data;
receive the first input using the first data entry area; and
enter the data in the first field

19. The system of claim 18, wherein the processor is further configured to:
apply a focus to the first field in response to a second input selecting the first field; and
wherein the processor is configured to draw the lens in response to application of the focus.

20. The system of claim 19, wherein the processor is further configured to:
display a second field of the form configured to receive additional data;
apply the focus to the second field;
redraw the lens comprising a second data entry area;
receive a third input comprising the additional data using the second data entry area; and
enter the additional data in the second field.

21. The system of claim 18, wherein the processor is configured to draw a widget adjacent to the lens.

22. A computer program product embodied in a computer readable medium and comprising computer instructions for:
displaying at least a portion of a form, the portion comprising a first field configured to receive data;
drawing a lens comprising a first data entry area to receive a first input comprising the data;
receiving the first input using the first data entry area; and
entering the data in the first field.

23. The computer program product of claim 22, the computer instructions further comprising applying a focus to the first field in response to a second input selecting the first field.

24. The computer program product of claim 22, wherein drawing the lens comprises drawing the lens in response to applying the focus.

25. The computer program product of claim 24, further comprising:
displaying a second field of the form configured to receive additional data;
applying the focus to the second field after the entering the data;
redrawing the lens comprising a second data entry area in response to the applying the focus to the second field;
receiving a third input comprising the additional data using the second data entry area; and
entering the additional data in the second field.

26. The computer program product of claim 22, the computer instructions further comprising drawing a widget adjacent to the lens.

27. The computer program product of claim 22, the computer instructions further comprising checking the first input for errors.
